(19) United States
(12) Patent Application Publication
(10) Pub. No.: US 2024/0100685 A1
(43) Pub. Date: Mar. 28, 2024

(54) MOBILE ELEVATING WORK PLATFORM SAFETY ACCESSORY

(71) Applicant: Jay Mislich, Pontiac, IL (US)

(72) Inventor: Jay Mislich, Pontiac, IL (US)

(21) Appl. No.: 17/952,428

(22) Filed: Sep. 26, 2022

(51) Int. Cl. B25H 3/06; B25H 3/04; B66F 17/00

(52) U.S. Cl. CPC B25H 3/06; B25H 3/04; B66F 17/006

(57) ABSTRACT

The present disclosure is for a mobile elevating work platform (MEWP) safety tray device. The safety tray device is secured to the rail of a MEWP by a hanging device of a first backplate. The size of the safety tray device may be increased by the adding one or more additional backplates. The additional backplates may be added to the safety tray device in order span a gap between multiple rails of a MEWP and to provide support across multiple rails of the MEWP. The safety tray device may further have accessory trays, swivel hooks, and tool holders that are further adjustable and modifiable.

### BACKGROUND

This disclosure relates generally to accessories used with aerial lifts.

As described herein, an aerial lift is a lifting device that includes a mobile elevating work platform (MEWP) that people may work from in order to access work areas that are difficult or impossible to reach from the ground. As referred to in the present disclosure, the terms “aerial lift” and “MEWP” are used interchangeably. MEWPs are frequently employed for lifting personnel, equipment, and tools on a worksite to an elevated or cantilevered position. For example, MEWPs may be relied on to install overhead pipes in building construction, access interior and/or exterior elevations in building construction, perform maintenance on aircrafts, or the like.

A danger that arises due to the use of a MEWP is the risk of having tools, materials, and/or equipment fall from the elevated platform of the MEWP onto individuals and/or structures below. The risk of having tools, materials, and/or equipment falling from the elevated platform of the MEWP may be a result of mishandling, unsecured storage, and/or inadvertent movement. Even small items, such as a screw or a bolt, are capable of penetrating a hard hat when dropped from a sufficient height. Therefore, methods and equipment for maintaining these items in a controlled manner is needed when operating and/or working from a MEWP.

There are numerous MEWP manufacturers. Accordingly, there are a variety of MEWP types and arrangements. What is also needed are methods of adjusting an apparatus for securing such items on a wide variety of MEWP that may operate and move in different manners. The safety trays of this disclosure provide such adjustment, are modular in nature, and are, thereby, compatible with multiple types of MEWPs and various platform and/or basket arrangements of the same, if not all.

### SUMMARY

The safety tray device of the present disclosure is for use on a mobile elevating work platform (MEWP). In one example, the safety tray device comprises a first backplate comprising a hanging device at a top end of the first backplate. A top end of a second backplate may be separably connected to a bottom end of the first backplate. The hanging device hooks onto, and is secured to, a top rail of a MEWP. A back side of the second backplate biases, and is supported on, a second rail (e.g., intermediate rail, lower rail, etc.) of the MEWP. The first backplate and the second backplate span a void between the top rail and the second rail, and is adjustable, or modifiable, by way of additional backplates or various sizes of backplates in order to accommodate varying sizes of voids and/or to span multiple voids.

In some examples, at least one safety accessory tray may be removably secured to one or more of the first backplate and the second backplate. Additionally, or alternatively, the first backplate or the second backplate may further comprise one or more swivel hooks. The one or more swivel hooks rotate within an aperture of one or more clips and are secured between multiple positions by one or more recesses within the one or more clips. The one or more swivel hooks may be rotated within the aperture of the one or more clips by raising the one or more swivel hooks within the apertures and rotating the one or more swivel hooks between the one or more recesses within the one or more clips. In one arrangement, the one or more swivel hooks are secured at, and extend beyond, one or more sides of the first backplate or the second backplate. In another arrangement, the one or more swivel hooks are secured at, and are retracted within, the face of one or more sides of the first backplate or the second backplate. Multiple swivel hooks may be arranged in any combination thereof, such as in an extended position only, an extended position and in a retracted position, or in a retracted position only. In one arrangement, the first swivel hook of the one or more swivel hooks mirrors (in an inverted arrangement) the second swivel hook of the one or more swivel hooks, relative to a centerline dividing the first backplate and the second backplate. In some examples, the one or more swivel hooks may be positioned between a first safety accessory tray of the at least one safety accessory tray on the first backplate and a second safety accessory tray of the at least one safety accessory tray on the second backplate. The at least one safety accessory tray and the one or more swivel hooks may be on a front side of the first backplate and/or a front side of the second backplate.

In some examples, the at least one safety accessory tray comprises one or more notches at the bottom of the safety tray for independently securing the at least one safety accessory tray to the top rail of a MEWP. The one or more notches at the bottom of the at least one safety accessory tray may be further secured to the top rail of a MEWP by a fastening device. In some examples, at least one or more backplates may extend from the at least one safety accessory tray secured to the MEWP. In other examples, both the at least one or more backplates may be secured to the top rail in addition to the at least one safety accessory tray. The safety accessory tray may additionally, or alternatively, be removably secured to the at least one or more backplates. The at least one safety accessory tray may further comprise a first extension member. The first extension member may be positioned within a track formed in a body of the at least one safety accessory tray for extending the length of the at least one safety accessory tray. The at least one safety accessory tray may further comprise a second extension member positioned with the track formed in a body of the at least one safety accessory tray. The second extension member may be for extending the length of the at least one safety accessory tray in the opposite direction of the first extension member. The at least one safety accessory tray may comprise aperture means for holding one or more tools. The aperture means for holding one or more tools may be located within the first extension member and/or the second extension member. The at least one safety accessory tray may comprise raised peripheral walls. The raised peripheral walls may form a basin, or basket, within the at least one safety accessory tray. The raised peripheral walls may be curved to securely hold a round bottom container. In some examples, the at least one safety accessory tray may comprise a tool holder apparatus extending from one or more of the raised peripheral walls. The tool holder apparatus of the at least one safety accessory tray may be cantilevered from the one or more of the raised peripheral walls and may be adjustable by extending and retracting through or from within one or more of the raised peripheral walls.

The foregoing and other objects, features, and advantages of the examples will be apparent from the following more detailed descriptions of particular examples as illustrated in the accompanying drawings wherein like reference numbers represent like parts of the examples.

### BRIEF DESCRIPTION OF THE DRAWINGS

Reference is made to the accompanying drawings in which particular examples, and further benefits of the examples, are illustrated as described in more detail in the description below, in which:

FIG. 1 shows a representation of several types of mobile elevating work platforms (MEWPs), in accordance with examples of the disclosure.

FIG. 2 is a perspective view of a MEWP, in accordance with examples of the disclosure.

FIG. 3 is a perspective view of a basket of a MEWP, in accordance with examples of the disclosure.

FIG. 4A is a top view of a safety tray, in accordance with an example of the disclosure.

FIG. 4B is a sectional view of a safety tray taken at section 4B-4B of FIG. 4A, in accordance with an example of the disclosure.

FIG. 5A is a top view of a safety tray, in accordance with an example of the disclosure.

FIG. 5B is a sectional view of a safety tray taken at section 5B-5B of FIG. 5A, in accordance with an example of the disclosure.

FIG. 5C is a top view of a safety tray, in accordance with an example of the disclosure.

FIG. 5D is a sectional view of a safety tray taken at section 5D-5D of FIG. 5C, in accordance with an example of the disclosure.

FIG. 6A is a top view of a safety tray, in accordance with an example of the disclosure.

FIG. 6B is a sectional view of a safety tray taken at section 6B-6B of FIG. 6A, in accordance with an example of the disclosure.

FIG. 6C is a top view of a safety tray, in accordance with an example of the disclosure.

FIG. 6D is a sectional view of a safety tray taken at section 6D-6D of FIG. 6C, in accordance with an example of the disclosure.

FIG. 7A is a top view of a safety tray, in accordance with an example of the disclosure.

FIG. 7B is a sectional view of a safety tray taken at section 7B-7B of FIG. 7A, in accordance with an example of the disclosure.

FIG. 8A is a top view of a safety tray, in accordance with an example of the disclosure.

FIG. 8B is a top view of a safety tray, in accordance with an example of the disclosure.

FIG. 9A is a perspective view of a safety tray device, in accordance with an example of the disclosure.

FIG. 9B is a perspective view of a safety tray device, in accordance with an example of the disclosure.

FIG. 9C is a front view of a safety tray device, in accordance with an example of the disclosure.

FIG. 9D is a side view of a safety tray device, in accordance with an example of the disclosure.

FIG. 9E is a top view of a safety tray device, in accordance with an example of the disclosure.

FIG. 10A is a front perspective view of a safety tray device on a MEWP, in accordance with an example of the disclosure.

FIG. 10B is a front perspective view of a safety tray device on a MEWP, in accordance with an example of the disclosure.

FIG. 10C is a front perspective view of a safety tray device on a MEWP, in accordance with an example of the disclosure.

FIG. 10D is a back perspective view of a safety tray device on a MEWP, in accordance with an example of the disclosure.

FIG. 11 is a top perspective view of a safety tray device on a MEWP, in accordance with an example of the disclosure.

### DETAILED DESCRIPTION

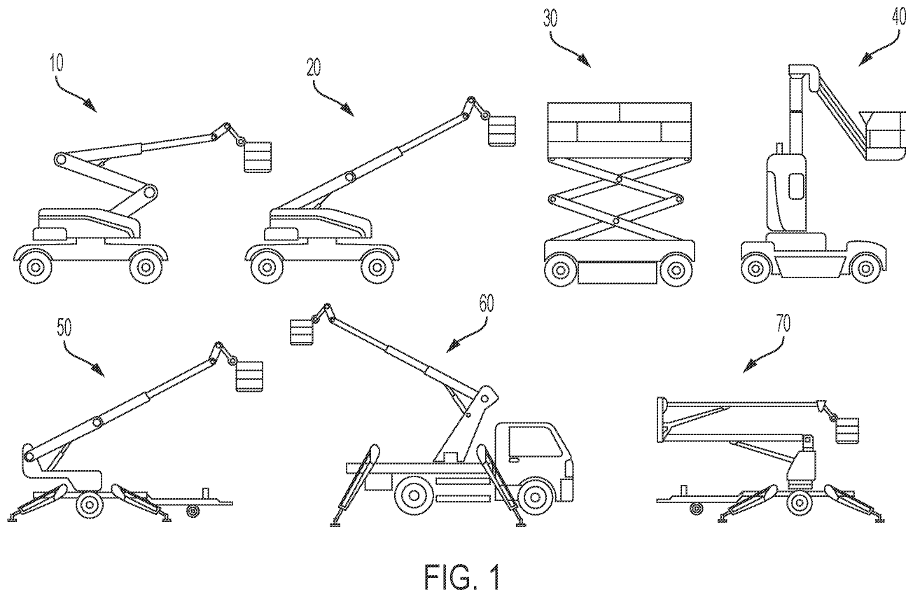

The present disclosure relates, generally, to accessories for use with aerial lifts, or MEWPs. FIG. 1 illustrates some examples of MEWPs. A driven articulated boom lift 10 is illustrated. A driven stick boom lift 20 is also illustrated. A scissor lift 30 is illustrated. A mast lift 40 is illustrated. Another stick boom lift 50 is illustrated. A boom truck 60, or bucket truck, is also illustrated. Finally, another articulating boom lift 70 is illustrated. Telescopic booms have boom sections which extend telescopically and include S-booms, stick booms, straight booms, or even cherry pickers. Articulating booms have multiple boom sections which hinge and typically include Z-booms, Zs, knuckle booms, up-and-over booms or zed booms. Scissor lifts have stacked lifting mechanisms of crossed tubes or bars which work in a scissor-like fashion and can be called vertical lifts, self-propelled platforms or slabs. MEWPs, also known as aerial lifts, or aerial work platforms, usually comprise an extendable lift mechanism or boom, and work platform or basket attached to the end of the lift mechanism which houses operators securely. All of these types of MEWPs are intended to be within the scope of the present disclosure.

As illustrated by the examples of FIG. 1 there are numerous arrangements for MEWPs. Some MEWPs may only be driven while the platform is in a stowed position. Other MEWPs may be driven while elevated but from the chassis. Other MEWPs may be driven while elevated and be controlled from the work platform. These different manners of operating a MEWP illustrate an operator of a MEWP, or other personnel, may move into harm's way below, or adjacent to, the platform of a MEWP at any given moment in time or, the MEWP may move, placing an unsuspecting individual into harm's way. As also illustrated by these examples, MEWPs are not only limited to vertical lift but they may also extend in a cantilevered and/or extended arrangement overtop locations not otherwise protected by the base of the MEWP. The operation or movement, alone, of MEWPs may result in shifting of tools, materials, and equipment maintained on the platform of the MEWP.

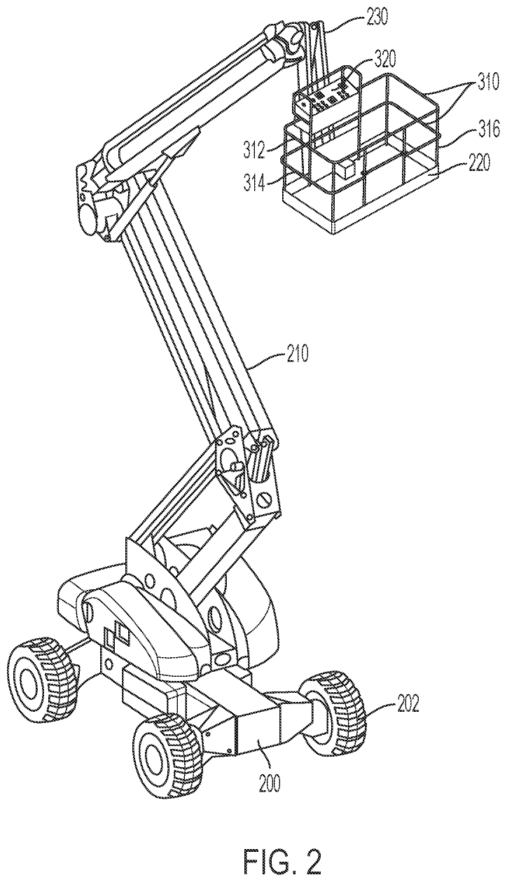

FIG. 2 is an illustration of one particular type of MEWP, a driven articulating boom lift 10. However, the features of this particular MEWP correspond to features found on many other MEWPs, such as those identified in FIG. 1. In the MEWP of FIG. 2, the MEWP comprises a base 200 with wheels 202, a boom 210, a powered drive system for driving and steering the wheels 202. Often a powered hydraulic system is utilized for manipulating the boom 210. The boom may be rotatably mounted to the base and comprises articulated sections that allow the boom to be raised and lowered. Other arrangements of boom can be provided to enable a range of different movements. For example, telescopic sections may be provided to allow the boom to extend up and down, and to be moved forwards, backwards and sideways relative to a base. The lift mechanism will have a vertical reach, which is the maximum height the floor of the platform will reach vertically. Work height is the maximum height at which work can be performed; the industry standard for work height is 6 feet higher than the vertical reach. The work platform may also be extended horizontally with some MEWPs. Other types of MEWPs have “up-and-over” capability providing flexibility to navigate obstacles.

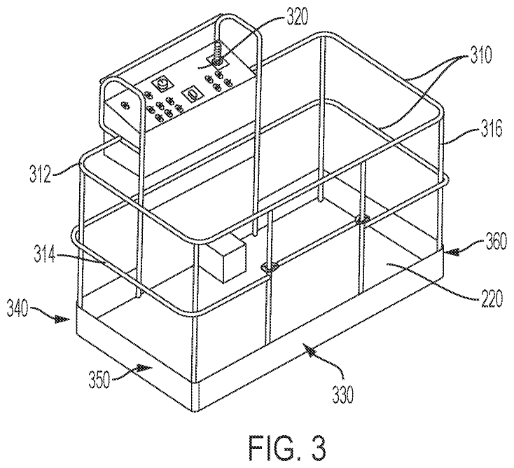

A platform 220, for supporting operators, equipment, and other payloads, is connected to the distal end of boom section 230 and is arranged to be stabilized such that the platform 220 is kept level. The work platform is called a basket as it generally resembles a basket or open-topped cage. A detailed view of the basket is shown in FIG. 3. As illustrated by FIGS. 2-3, protective rails 310 are provided, for example, at about waist height, surrounding the perimeter of the platform 220 to prevent the operator from falling from the platform 220. A top rail 312 and an intermediate rail 314 are illustrated. Further, bars 316 or netting may be provided between the protective rails 310 and the platform 220 such that the platform and rails are commonly referred to together as a basket. The basket generally comprises the platform 220 and protective railing 310 along with a platform control panel 320 which houses a variety of controls based on the type, make, and model of MEWP. Such controls can include the lift, drive, platform rotation, boom functions, auxiliary power, and emergency stop controls and permits an operator standing in the basket to maneuver the work platform as desired. The protective rails 310 do not obstruct access to the control panel 320.

The Occupational Safety and Health Administration section of the United States Department of Labor has set standards for the use of MEWPs. Most states have adopted OSHA standards. For purposes of this disclosure, OSHA standards and sizing are adopted.

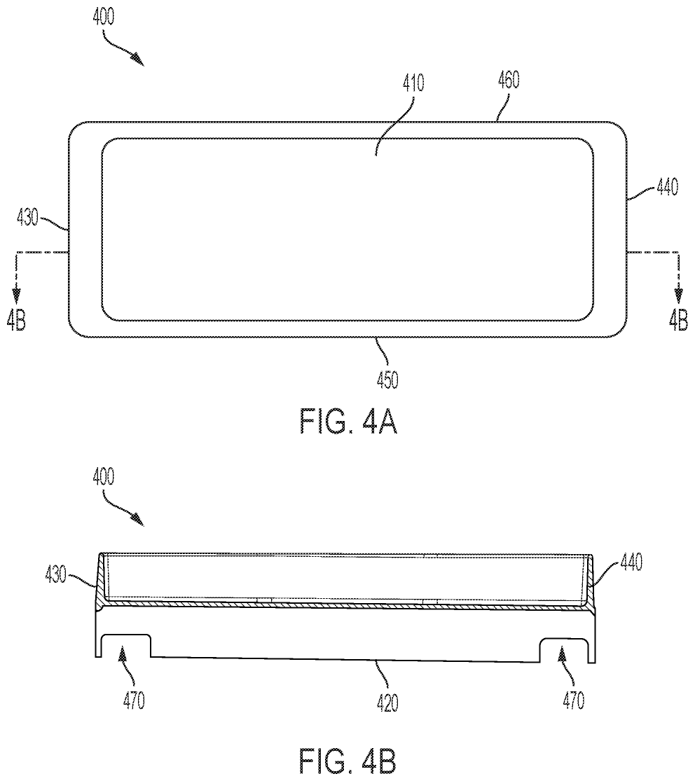

Referring now to FIGS. 4A-4B, which shows an example of the MEWP safety tray 400 of the present disclosure. The safety tray 400 of the present disclosure comprises six faces: a top face 410, a bottom face 420, a left face 430, a right face 440, a front face 450, and a back face 460. Each of the six faces comprises four sides. The faces are arranged to form a tray. The top face's four sides are a top face first length side, a top face second length side, a top face first width side, and a top face second width side. The bottom face's four sides are a bottom face first length side, a bottom face second length side, a bottom face first width side, and a bottom face second width side. The left face's four sides are a left face first width side, a left face second width side, a left face first height side, and a left face second height side. The right face's four sides are a right face first width side, a right face second width side, a right face first height side, and a right face second height side. The front face's four sides are a front face first length side, a front face second length side, a front face first height side, and a front face second height side. The back face's four sides are a back face first length side, a back face second length side, a back face first height side, and a back face second height side.

The six faces are formed together or connected together so that the top face first length side is connected to the front face first length side; the top face second length side extends from or is connected to the back face first length side; the top face first width side extends from or is connected to the left face first width side; the top face second width side extends from or is connected to the right face first width side; the left face second width side extends from or is connected to the bottom face first width side; the right face second width side extends from or is connected to the bottom face second width side; the bottom face first length side extends from or is connected to the front face second length side; the bottom face second length side extends from or is connected to the back face second length side; the front face first height side extends from or is connected to the left face first height side; the front face second height side extends from or is connected to the right face first height side; the back face first height side extends from or is connected to the left face second height side; and the back face second height side extends from or is connected to the right face second height side.

The safety tray 400 (as illustrated by FIG. 4, for example) may span the width of the MEWP platform, or protective rails, by reaching from the top rail 312 of the basket front 330 (as illustrated by FIG. 3) to the top rail 312 of the basket back 340 (as also illustrated by FIG. 3). However, in some examples, the safety tray 400 may span the length of the platform depending on the overall size of the platform. In such examples, the safety tray 400 reaches from the top rail 312 of the basket's first side 350 (as illustrated by FIG. 3) to the top rail 312 of the basket's second side 360 (as illustrated by FIG. 3).

The safety tray is mounted on the platform by being secured to the basket rails. Securing the safety tray above the floor maximizes workspace and prevents operators from tripping on tools when they move around on the platform.

In one example of the disclosure, the safety tray 400 is secured to the basket rails 310 (as illustrated by FIG. 3) by notches 470 (as illustrated by FIG. 4B) located on the bottom face 420 of the safety tray 400. The notches 470 fit over the basket rail 310 (as illustrated by FIG. 3). Additionally, or alternatively, the safety tray is secured to the basket rails by a fastening device that temporarily attaches the device to the rails. In one example, the safety tray may be secured to the basket rails by both notches that fit over the basket rail and a fastening device that removably attaches the safety tray to the rail by wrapping underneath the basket rail so that the rail is squeezed between the safety tray and the fastening device. The safety tray may be temporarily fastened in position on the platform through a variety of fastening devices known in the art, including, but not limited to ties, pins, bands, hook and loop, magnetic fasteners, and others. In other examples, the safety tray may be permanently fastened to the platform.

The safety tray may be made of many lightweight solid materials known in the art, such as plastic or metal for nonlimiting examples. An example is constructed so it is held together by processes known in the art.

In some examples, the safety tray is not a solid piece of material through the full thickness of the safety tray. Rather, there are strengthening members that support the structure of the safety tray while keeping the weight of the tray to a minimum. One example comprises strengthening members made of the same material the safety tray is made of, and the strengthening members are located on the bottom face of the safety tray. The strengthening members may be added to the safety tray. Additionally, or alternatively, the strengthening members may be molded with or onto the safety tray.

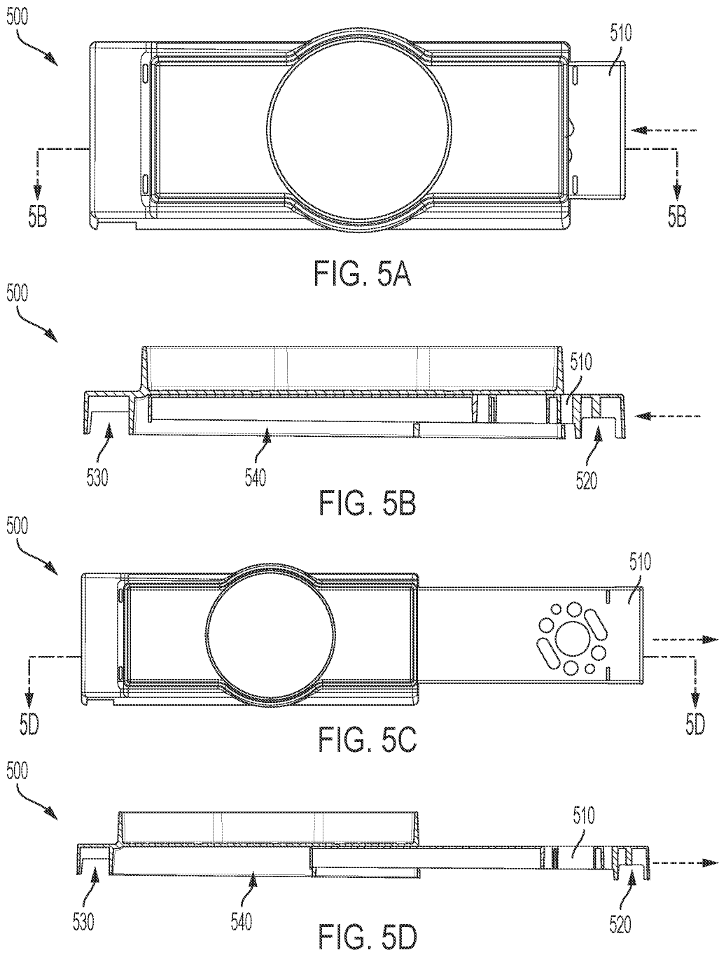

The overall length of the safety tray may range from about 15 inches to about 48 inches. In one example, the length of the safety tray is fixed, such as that illustrated by FIGS. 4A-4B. Referring to FIGS. 5A-5D, in one example, a safety tray 500 may comprise at least one extendable-retractable extension member 510 (referred to herein more generally as extension member) which allows the safety tray to adjust size. In the examples of FIGS. 5A-5D the length of the safety tray 500 is adjustable. In such an example, one method of attachment 520 to a basket rail 310 (as illustrated by FIG. 3) is located on the extension member and one method of attachment 530 to a basket rail 310 (as illustrated by FIG. 3) is located on the safety tray body. The extension member 510 is positioned within a track 540, or guide, extending from or formed in the body of the safety tray 500. The track 540, or guide, aligns and supports the extension member 510 upon the safety tray 500. FIGS. 5A and 5B are directed to an example of the safety tray with the extension member 510 in a fully retracted position and, thereby, may be smaller than the basket rails 310 allowing for compact transport to and from the worksite. FIGS. 5C and 5D are directed to an example where the extension member 510 is extended in order to secure the safety tray 500 to the MEWP basket rail 310 (as illustrated by FIG. 3). In another example, the safety tray 500 comprising the extension member 510 may still be secured to the MEWP basket when the extension member 510 is partially extended and even in the fully retracted position. In such examples, the overall length of the safety tray may be at least 22 inches while in the fully retracted position and the length can be extended allowing the safety tray to fit multiple sized baskets and/or rail assemblies.

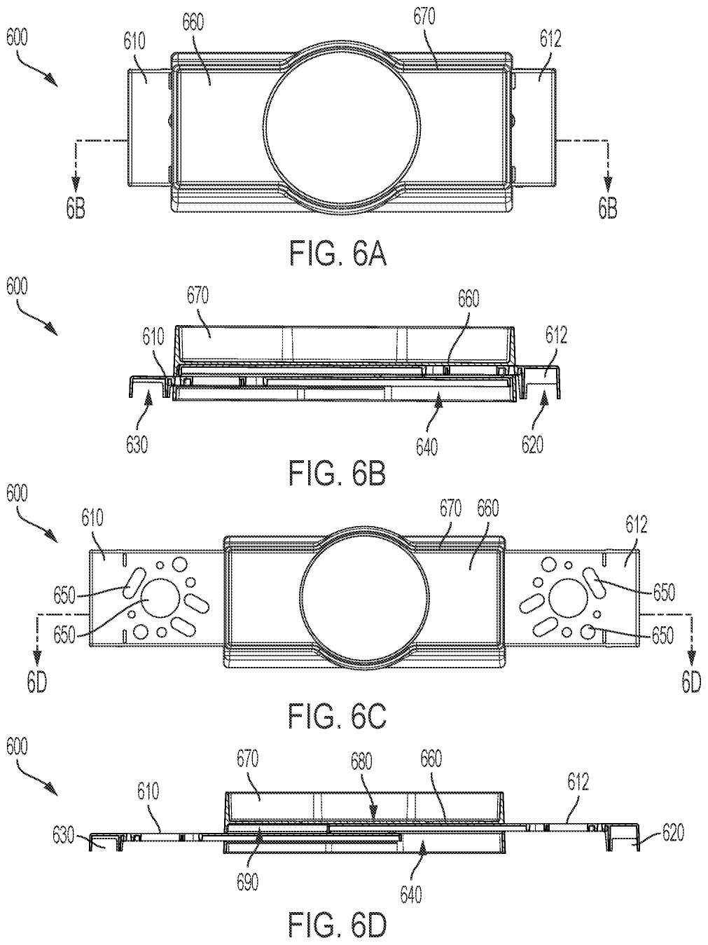

As illustrated by FIGS. 6A-6D, a safety tray 600 may comprise two extendable-retractable extension members 610, 612 (referred to herein more generally as extension members) where the two extension members 610, 612 may be extended at the same time (FIGS. 6C and 6D), one at a time, or both retracted at the same time (FIGS. 6A and 6B). In such an example, one means for attachment 630 is located on a first retractable extension member 610 and the other means for attachment 620 is located on the second extension member 612. In an example of the safety tray 600 comprising two extension members (FIGS. 6A-6D), when the extension members 610, 612 are in the fully retracted position the overall length of the safety tray 600 is smaller than the basket rails allowing for compact transport to and from the worksite. In such an example, at least one of the extension members 610, 612 may be extended in order to secure to the MEWP basket. In another example, both extension members 610, 612 are extended in order to secure to the MEWP basket. The extension member 610, 612 may be positioned within a track 640, or guide, extending from or formed in the body of the safety tray 600. The track 640, or guide, aligns and supports the extension member 610 upon the safety tray 600. In the examples of FIGS. 6A and 6B, the first extension member 610 is positioned above the second extension member 612. In such an arrangement the thickness or depth of the method of attachment 620, 630 may reflect (e.g., may vary, may be at different thicknesses, etc.) the difference in elevation between the first and second extension members 610, 612 based on their position in the track 640 (as they may be stacked on top of one another within the track) in order to maintain the safety tray in a level position relative to the rails of the MEWP. The first extension member 610 moves independent of the second extension member 612. In some examples, the extension members 610, 612 may be on independent tracks 640, or guides. In some examples, the safety tray comprising two extension members 610, 612 may be secured to the MEWP basket when the extension members are in the fully retracted position (FIGS. 6A and 6B). In such an example, the overall length of the safety tray is at least 22 inches in the fully retracted position and the length can be extended allowing the safety tray to fit multiple sized baskets.

The overall width of the safety tray may range from about 3 inches to about 15 inches. In some examples, the overall width of the safety tray may range from about 5 inches to about 9 inches. In some examples, the overall width of the safety tray may range from about 6 to about 8 inches.

The height of the safety tray, not including the raised peripheral walls 670, ranges from about 0.5 inches to about 12 inches. In some examples, the height of the safety tray, not including the raised peripheral walls 670, ranges from about 0.75 inches to about 5 inches. In some examples, the height of the safety tray, not including the raised peripheral walls 670, ranges from about 1 inch to about 3 inches.

Still referring to FIGS. 6A-6D, the safety tray may comprise at least one means 650 for holding one or more tools. In some examples, this means 650 for holding one or more tools is a strategically placed aperture allowing the tool to hang through the safety tray 600. The means 650 for holding tools may be of various sizes and shapes. For example, the means 650 for holding tools may be round, oval, oblong, triangular, rectangular in shape as a few non-limiting examples. In examples where there are more than one means 650 for holding more than one tools, the means 650 may vary in size and arrangement from one another or can be similar in shape and size. In some examples, the one or more means 650 for holding tools are arranged in various combinations and sizes. In some examples, the one or more means 650 for holding tools are similar in size. In some examples, the means 650 for holding tools is located in the safety tray body 660 itself, so that the means 650 extends through the top face 680 and through the bottom face 690. In other examples, the means 650 for holding tools is located on the extension members 610, 612, or for examples that have two extension members 610, 612, the means 650 for holding tools is located on one, or both, of the extension members 610, 612.

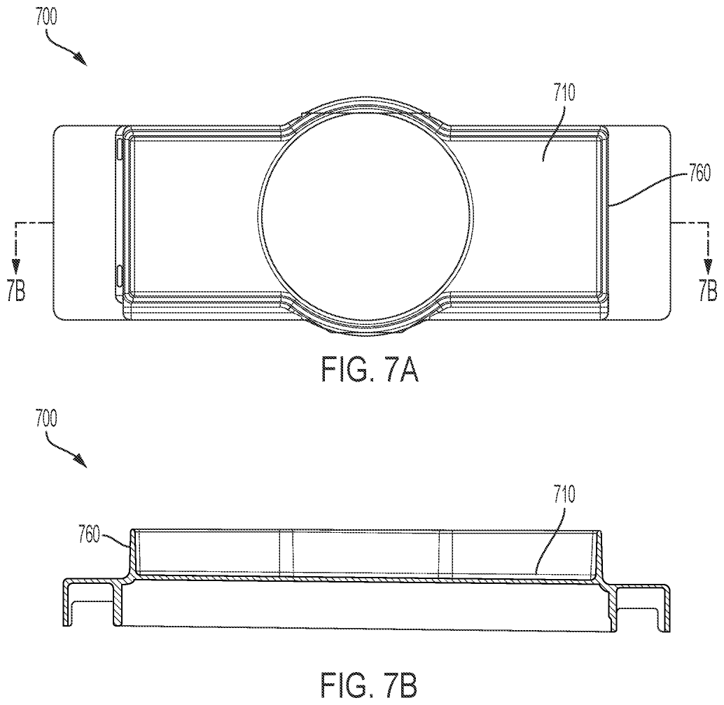

Turning now to FIGS. 7A-7B, in some examples, there are raised peripheral walls 760 perpendicularly attached to and extending from the safety tray body 710, creating a walled tray. In some examples, the raised peripheral walls 760 are at least about 0.1 inches in height and can range up to about 12 inches in height. In some examples, the walls of the walled tray are foldable. As seen in FIGS. 7A-7B, certain examples of the disclosure comprise walls 760 of the walled tray 700 that are not straight, rather the walls running along the length of the tray 700 are shaped (either curved or angled, for example) as to securely hold a round bottom container, or even a container of yet another shape. In such examples where the walls 760 are shaped to securely hold a round bottom container with a diameter ranging from about 6 inches to about 7.5 inches, such as a round bottom paint canister. In some examples where the walls 760 are shaped to securely hold a one-gallon paint container, the container is a square bottom plastic container such as described in U.S. Pat. Nos. 6,896,156 and 7,040,509, incorporated herein by reference for this purpose.

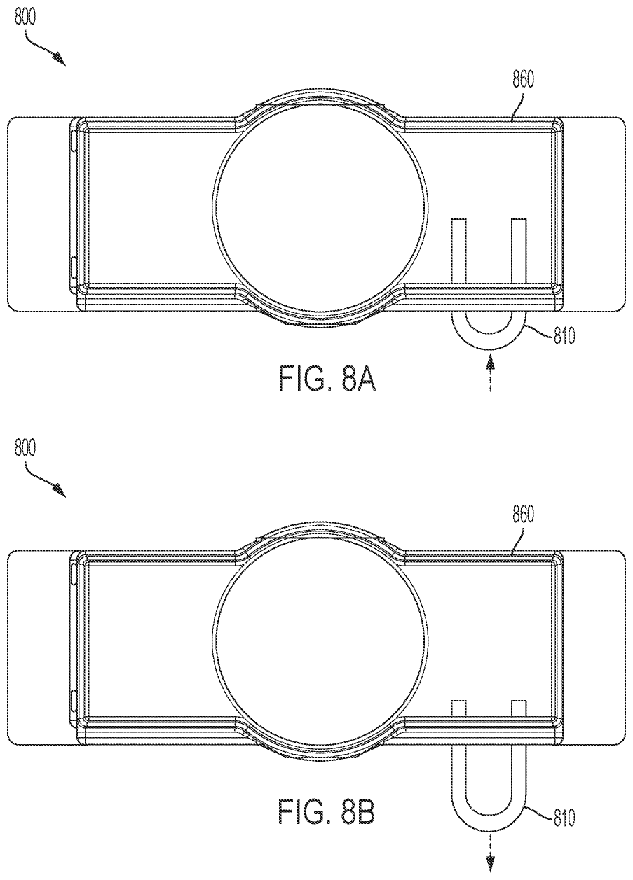

Referring now to FIGS. 8A-8B, in some examples, the walled tray 800 comprises an attached holder apparatus 810 on at least one of its walls 860. By example, the holder apparatus 810 may extend through openings through the walls 860. In some examples, at least one of the walls 860 comprises more than one attached holder apparatus 810. In some examples, the attached holder apparatus 810 is attached to the walled tray in a fixed position. However, as depicted in FIGS. 8A and 8B, in some examples, the one or more attached holder apparatuses 810 are extendable and retractable such that FIG. 8A represents an attached holder apparatus 810 retracted and FIG. 8B represents an attached holder apparatus 810 extended. Examples of an attached holder apparatus include, but are not limited to, a drill holster, hammer loop, caulking gun loop, tape hanger, clip, hook, and others known in the art.

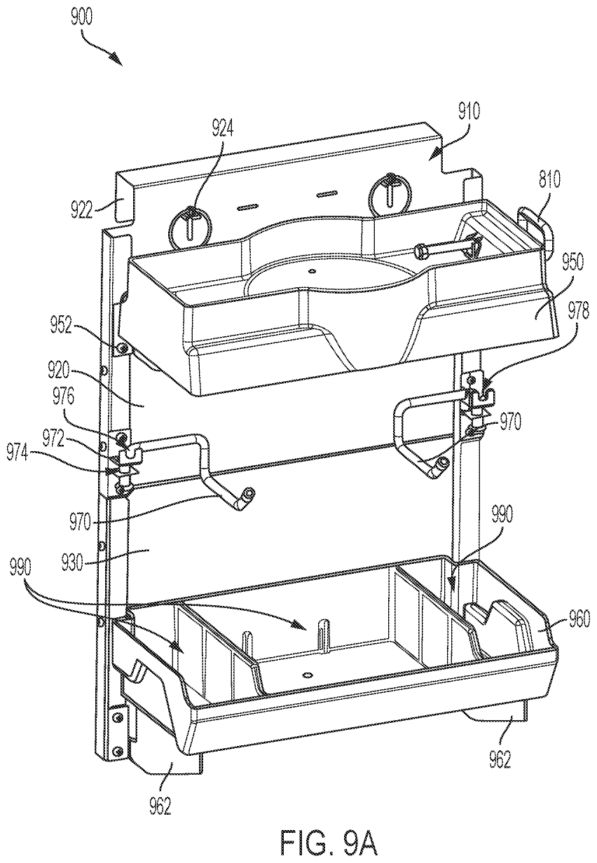

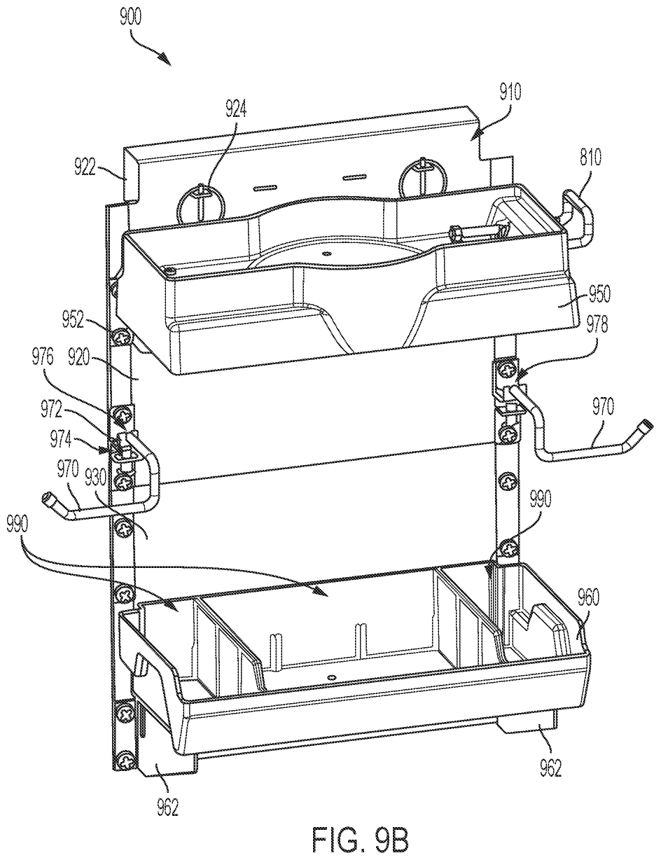

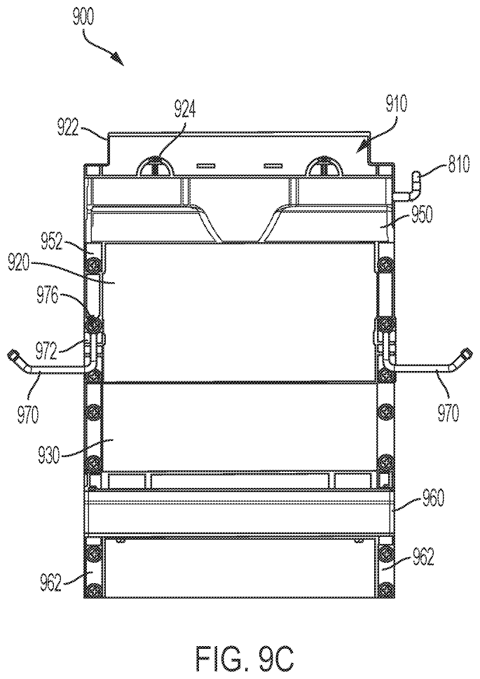

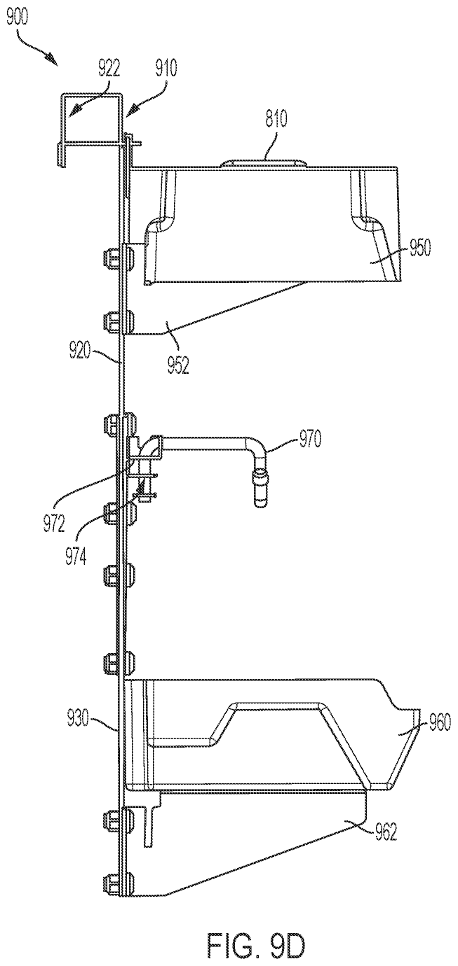

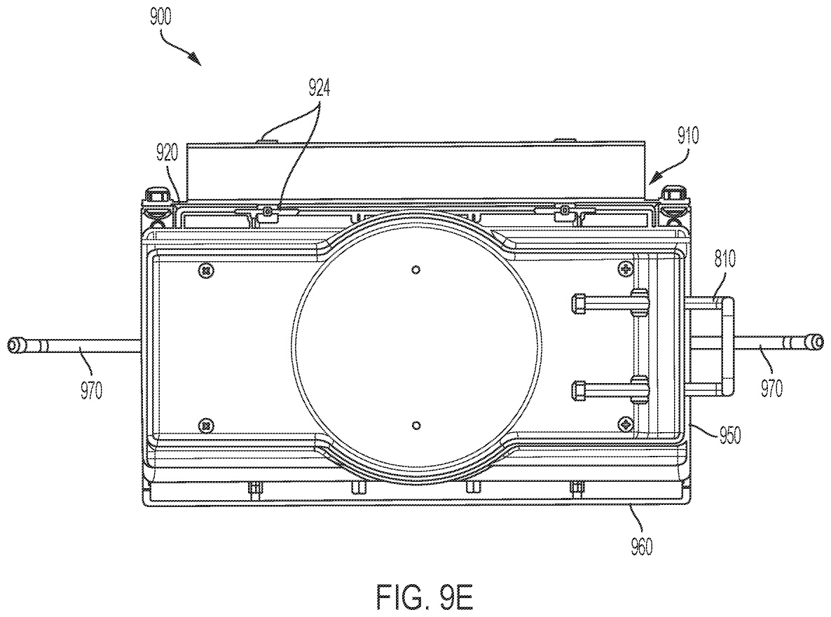

Turning now to FIGS. 9A-9E, a MEWP safety tray device 900 is disclosed. FIGS. 9A-9E illustrate a safety tray device 900 comprising a modular hanging device 910 that may be relied on to support one or more safety trays 950, 960 and/or additional supports and/or accessories, as further described below. It is modular in that the modular hanging device 910 comprising a first backplate 920 with a hanger 922 for suspending the modular hanging device 910 from a rail assembly of the MEWP, wherein the modular hanging device 910 is modifiable and may be accessorized. The modular hanging device 910 is compatible with and may be outfitted with additional backplates, safety trays, and/or supports, as will be further described below. Thereby, the size of the modular hanging device is adjustable based upon the rail assembly of the MEWP, the platform arrangement of the MEWP, additional equipment and/or personnel desired on the platform of the MEWP, or the like. By example, the MEWP safety tray device 900 of FIGS. 9A-9E may comprise a second backplate 930 extending below and supported by the first back plate 920. The second backplate 930 may be provided to extend from and below the first backplate 920 wherein the second backplate 930 extends the modular hanging device 910 assembly from a top rail of the MEWP to a lower intermediate, or bottom rail, of the MEWP basket (as described above with respect to FIGS. 2-3). Thereby, the second backplate 930 maintains the safety tray device 900 within the basket assembly of the MEWP, as opposed to allowing the safety tray device 900 from swinging into the void formed between the top rail and a lower intermediate, or bottom rail, of the MEWP basket.

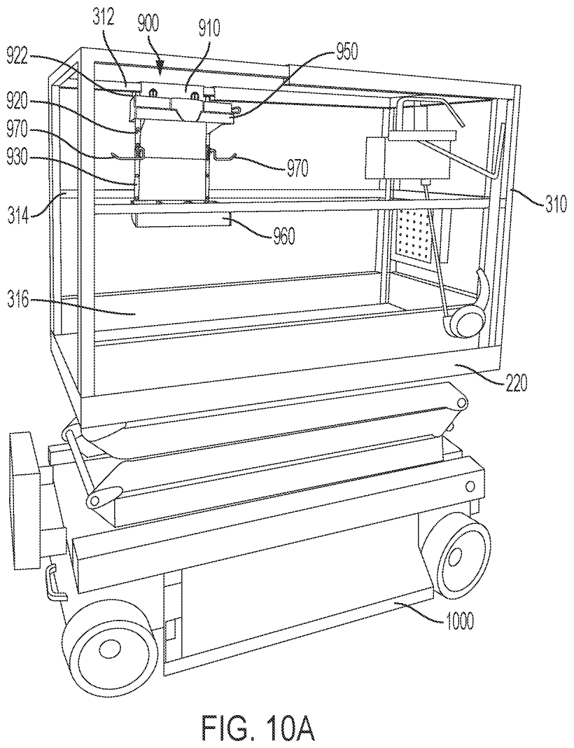

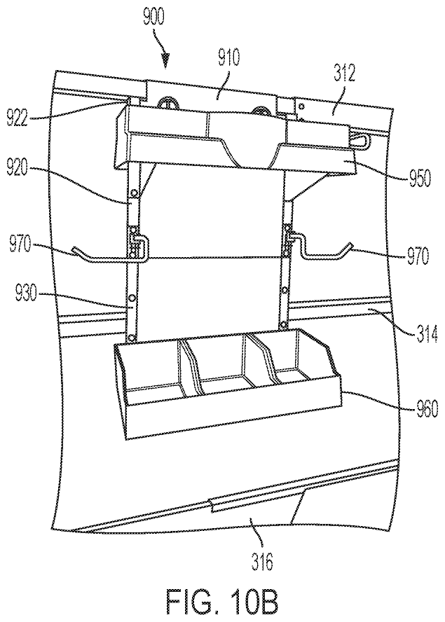

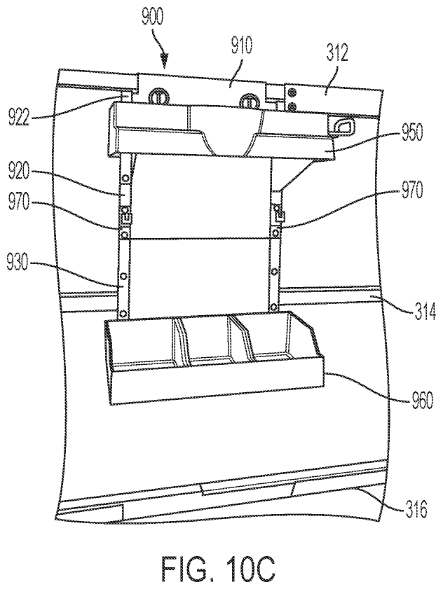

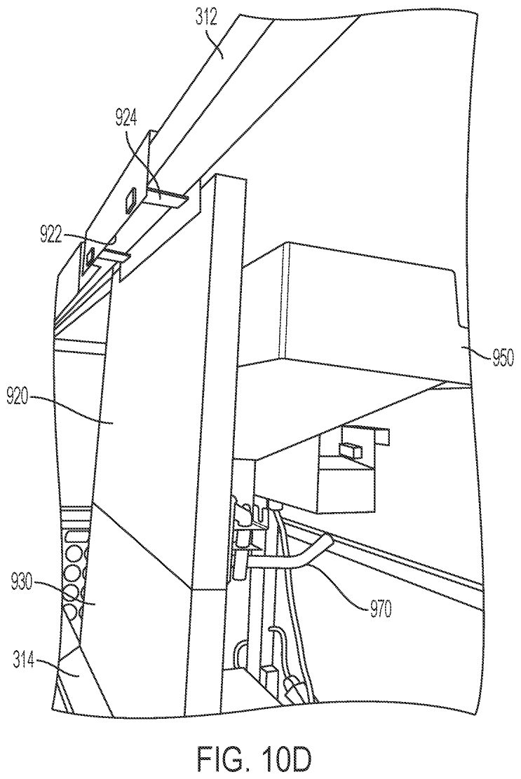

This is best illustrated by FIGS. 10A-10D. In FIGS. 10A-10D a safety tray device 900 is shown in use on a MEWP 220. In FIGS. 10A-10D, the safety tray device 900 comprises a modular hanging device 910 having a first backplate 920 with a hanger 922 and a second backplate 930 attached to and extending below the first backplate 920. The second backplate 930 extends the modular hanging device 910 from the top rail 312 of the protective rails 310 to an intermediate rail 314 of the protective rails 310. This rigidly secures the safety tray device 900 to the MEWP 220 by way of the hanger 922 where inadvertent movement of safety tray device 900 is further limited by the addition of the second backplate 930 against the intermediate rail 314. Additional backplates, such as a third backplate, may further extend from the second backplate 930 in the same manner the second backplate 930 extends from the first backplate 920, such as in the event the span between a top rail 312 and intermediate rail 314 of the protective rails 310 are greater than the size of the hanging device 910 having a first backplate 920 and a second backplate 930 only. Additionally, or alternatively, additional backplates may be utilized to support additional safety trays 950, 960 and/or tools, materials, or supplies. Further, additional backplates may be utilized to further extend the modular hanging device 910 from the top rail 312 of the protective rails 310 to a toe kick 318 positioned at a MEWP 220. FIG. 10A illustrates this arrangement on a scissor lift 1000. FIG. 10B is a closer view of the arrangement of the safety tray device 900 of FIG. 10A on the scissor lift 1000, further illustrating swivel hooks 970 in an extended arrangement, as further described below with respect to FIGS. 9A-9E. FIG. 10C is yet another closer view of the arrangement of the safety tray device 900 on the scissor lift 1000, further illustrating swivel hooks 970 in a retracted arrangement, as further described below with respect to FIGS. 9A-9E. FIG. 10D is a backside view of the safety tray device 900 secured to the scissor lift 1000, illustrating the hanger 922 and the manner a first backplate 920 is further extended by way of the second backplate 930 to span the void between a top rail 312 and an intermediate rail 314 of the protective rails 310.

Returning to FIGS. 9A-9E, the hanger 922 of the first backplate 920 may simply be a hook for extending overtop a top rail of a MEWP basket. The hanger 922 may be a single bent plate formed in, or extending from, the top of the first backplate, as illustrated by FIG. 9A. Additionally, or alternatively, the hanger 922 may be multiple hooks extending from, attached to, or positioned to the top of the first backplate, or the like. In any arrangement, the hanger 922 is placed overtop a top rail of the basket of the MEWP such that it engages the top of the top rail and the top rail is positioned front-to-back within the hanger 922, or hooks. The hanger 922 may be further secured, or temporarily fastened, at the base of the top rail by extending a pin 924, or plate through the hook and into the backplate from beneath the top rail, thereby, securing the first backplate 920 to the top rail and preventing the safety tray device 900 from being lifted from the rail assembly. The hanger 922 may also be temporarily fastened in position on the platform through a variety of fastening devices known in the art, including, but not limited to ties, pins, bands, hook and loop, magnetic fasteners, or the like. The first backplate 920 then extends to below the top rail in a direction of a lower rail such as, for example, in the direction of an intermediate rail, bottom rail, or toe kick of the MEWP basket.

The second backplate 930 may be provided to further extend the first backplate 920 to the intermediate rail, bottom rail, or toe kick, so that it may be supported against, or posted upon, the intermediate rail, bottom rail, or toe kick of the MEWP basket. The second backplate 930 may be rigidly secured to the first backplate 920 by way of one or more extensions, plates, rods, or the like extending from the first backplate 920 onto to the second backplate 930. The one or more extensions may be bolted, pinned, or the like to each of the first backplate 920 and the second backplate 930. Additionally, or alternatively, the second backplate 930 may be secured directly to the first backplate 920 in similar fashion.

Once a user determines the backplate arrangement that is compatible with a particular MEWP basket the backplates 920, 930 may be further accessorized based upon a particular use within the MEWP basket. One or more trays 950, 960 may be added to one or more of the backplates 920, 930 of the MEWP safety tray device 900 of the present examples. The one or more trays 950, 960 may include the features corresponding to the safety tray as described in any of the examples of FIGS. 4A-4B, 5A-5D, 6A-6D, 7A-7B, 8A-8B, and/or others. Any such trays 950, 960 may be fastened directly to one or more backplates 920, 930 and supported from one or more backplates 920, 930. They may be secured directly to the respective backplates 920, 930 and/or they may be supported from the respective backplates 920, 930 by way of supports 952, 962 attached to and extending from the respective backplates 920, 930, respectively. Multiple trays may additionally, or alternatively, be directly fastened to a respective backplate 920, 930. Multiple trays may be fastened across a single backplate. Multiple trays may be fastened across multiple backplates. In an alternative example, a backplate may be fastened to, and extend from, a safety tray of FIGS. 4A-4B, 5A-5D, 6A-6D, 7A-7B, and/or 8A-8B supported from a rail of the basket of the MEWP. In other words, the safety tray may support one or more backplates extending therefrom where the safety tray is supported by the protective rail of the basket of the MEWP as described with respect to the safety tray examples described above. Thereby, the horizontal arrangement of the safety trays of the prior examples are compatible with the vertical arrangement of the safety tray device of the present example, and vice versa, under several different arrangements to fit a need and MEWP arrangement.

Additional accessories may be added, attached, or extend from the backplates, and or the previously described safety trays, of the present disclosure. Still referring to FIGS. 9A-9E, an example of such an accessory includes rotatable and/or retractable arms (e.g., also referred to herein as swivel hooks) 970 that may further support tools or equipment. The swivel hooks are retractable such that they may be retracted to within the width of the backplate. This allows for compact transport to and from the worksite, as well as allowing the swivel hooks 970 to be being placed out of the way from a perimeter of the safety tray device 900 when not in use. FIG. 9A illustrates retracted swivel hooks 970 and FIGS. 9B-9D illustrates extended swivel hooks 970.

The swivel hooks 970 may be retracted by rotating them within one or more apertures 974 extending through one or more clips 972 supported from a backplate. One or more clips 972 may further comprise one or more recesses 976, 978 for seating the swivel hooks 970 in the extended position and/or the retracted position. For example, the arrangement of FIG. 9 provides a forward facing recess 976 for securing the swivel hooks 970 in an extended position and a side facing recess 978 for securing the swivel hooks 970 in a retracted position. In the example of FIGS. 9A-9D two swivel hooks 970 are provided and are positioned between two safety trays 950, 960, a first safety tray 950 above and a second safety tray 960 below. The swivel hooks 970 may be relied on to support tools, materials, or equipment individually and/or across both (or multiple) swivel hooks in the retracted arrangement, the extended arrangement, or a combination thereof. To move the swivel hooks 970 they may be lifted within the apertures 974 to above a first recess 976 and rotated in the apertures 974 until they are positioned and rest within an adjacent second recess 978, or vice versa. Additional recesses may be provided to provide additional positions about the apertures. The swivel hooks 970 may be of a bent arm arrangement forming one or more hooks laterally and/or vertically for supporting tools, materials, or equipment (hence, forming a swivel hook). Accordingly, tools, materials, or equipment may be hung from the hooks regardless of whether the swivel hooks 970 are retracted or extended.

As illustrated by FIGS. 9A-9E the top safety tray 950 has an arrangement as previously described in FIGS. 7A-7B and 8A-8B. Specifically, the top safety tray 950 comprises walls shaped (e.g., curved, circular, etc.) to securely hold a round bottomed container, as described above with respect to FIGS. 7A-7B. The top safety tray 950 additionally comprises a holder apparatus 810 that is extendable and retractable, as described with respect to FIGS. 8A-8B. As also illustrated by FIGS. 9A-9D, the bottom safety tray 960 comprises compartments for storing supplies. The safety trays 950, 960 may be of any configuration or arrangement as described herein.

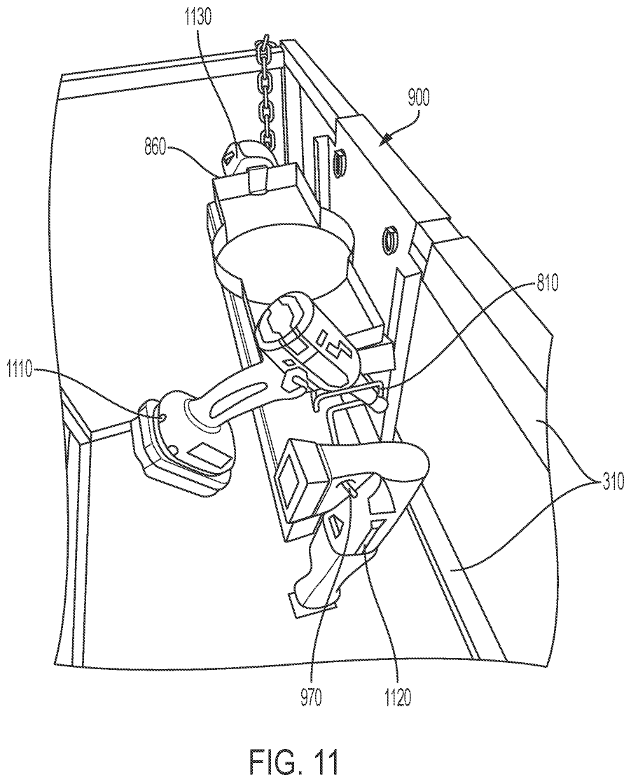

Turning now to FIG. 11, a safety tray device 900 is shown in use. The safety tray device 900 is secured to a rail assembly 310 of a MEWP. A drill 1110 is inserted into and supported by a holder apparatus 810 extended in a manner to securely hold said drill 1110. A reciprocating saw 1120 is further hooked onto, or secured by, a swivel hook 970 positioned in an extended arrangement. Further, a tape measure 1130 is clipped onto a raised peripheral wall 860, such as that described with respect to FIGS. 8A-8B.

While this invention has been described with reference to examples thereof, it shall be understood that such description is by way of illustration only and should not be construed as limiting the scope of the claimed examples. Accordingly, the scope and content of the examples are to be defined only by the terms of the following claims. Furthermore, it is understood that the features of any example discussed herein may be combined with one or more features of any one or more examples otherwise discussed or contemplated herein unless otherwise stated.

What is claimed is:

1. A safety tray device on a mobile elevating work platform, the safety tray device comprising:
a first backplate comprising a hanging device at a top end of the first backplate;
a second backplate having a top end separably connected to a bottom end of the first backplate;
wherein the hanging device hooks and is secured to a top rail of a mobile elevating work platform and a back side of the second backplate biases and is supported on a second rail of the mobile elevating work platform; and
wherein at least one safety accessory tray is removably secured to one or more of the first backplate and the second backplate.

2. The safety tray device of claim 1, wherein the first backplate and the second backplate span a void between the top rail and the second rail.

3. The safety tray device of claim 1, wherein the first backplate or the second backplate further comprises one or more swivel hooks.

4. The safety tray device of claim 3, wherein the one or more swivel hooks rotate within an aperture of one or more clips and are secured between multiple positions by one or more recesses within the one or more clips.

5. The safety tray device of claim 4, wherein the one or more swivel hooks are rotated within the aperture of the one or more clips by raising the one or more swivel hooks within the aperture of the one or more clips between the one or more recesses within the one or more clips.

6. The safety tray device of claim 3, wherein the one or more swivel hooks are secured at and extend beyond one or more sides of the first backplate or the second backplate.

7. The safety tray device of claim 3, wherein the one or more swivel hooks are secured at and are retracted within one or more sides of the first backplate or the second backplate.

8. The safety tray device of claim 3, wherein the one or more swivel hooks are positioned between a first safety accessory tray of the at least one safety accessory tray on the first backplate and a second safety accessory tray of the at least one safety accessory tray on the second backplate.

9. The safety tray device of claim 8, wherein the at least one safety accessory tray and the one or more swivel hooks are on a front side of the first backplate or a front side of the second backplate.

10. The safety tray device of claim 3, wherein a first swivel hook of the one or more swivel hooks mirrors a second swivel hook of the one or more swivel hooks, relative to a centerline dividing the first backplate and the second backplate.

11. The safety tray device of claim 1, wherein the at least one safety accessory tray comprises one or more notches at the bottom of the at least one safety accessory tray for independently securing the at least one safety accessory tray to the top rail of the mobile elevating work platform.

12. The safety tray device of claim 11, wherein the one or more notches at the bottom of the at least one safety accessory tray are further secured to the top rail of the mobile elevating work platform by a fastening device.

13. The safety tray device of claim 1, wherein the at least one safety accessory tray comprises a first extension member positioned within a track formed in a body of the at least one safety accessory tray for extending a length of the at least one safety accessory tray.

14. The safety tray device of claim 13, wherein the at least one safety accessory tray further comprises a second extension member positioned with the track formed in the body of the at least one safety accessory tray for extending the length of the at least one safety accessory tray in an opposite direction of the first extension member.

15. The safety tray device of claim 1, wherein the at least one safety accessory tray comprises aperture means for holding one or more tools.

16. The safety tray device of claim 13, wherein the at least one safety accessory tray comprises aperture means for holding one or more tools and the aperture means are located within the first extension member.

17. The safety tray device of claim 1, wherein the at least one safety accessory tray comprises raised peripheral walls forming a basin within the at least one safety accessory tray.

18. The safety tray device of claim 17, wherein the raised peripheral walls are curved to securely hold a round bottom container.

19. The safety tray device of claim 17, wherein the at least one safety accessory tray comprises a tool holder apparatus extending from one or more of the raised peripheral walls.

20. The safety tray device of claim 19, wherein the tool holder apparatus of the at least one safety accessory tray is cantilevered from one or more of the raised peripheral walls and is adjustable by extending and retracting within one or more of the raised peripheral walls.
